(19) United States
(12) Patent Application Publication
(10) Pub. No.: US 2004/0062783 A1
(43) Pub. Date: Apr. 1, 2004

(54) Composition for combating insects and parasites

(76) Inventors: Xavier De Sloovere, Anzegem (BE); Didier Desschans, Kortrijk-Heule (BE); Gino Sirejacob, Ebergem (BE)

Correspondence Address: HOVEY WILLIAMS LLP, 2405 GRAND BLVD., SUITE 400, KANSAS CITY, MO, 64108, US

(21) Appl. No.: 10/322,285

(22) Filed: Dec. 17, 2002

(30) Foreign Application Priority Data
Sep. 27, 2002 (WO) PCT/BE02/00149

(51) Int. Cl. A01N 25/28; A01N 25/08; A01N 25/26

(52) U.S. Cl. 424/409

(57) ABSTRACT

Composition for combating insects, mites, ticks and parasites, said composition comprising at least as active agent coated siliceous containing particles, said particles having an average primary particle size of less than 100 nm, advantageously of less than 50 nm, preferably comprised between 10 and 40 nm, whereby the coating is a hydrophobic silicon containing coating

### RELATED APPLICATIONS

This application claims the benefit of PCT Application No. PCT/BE02/00149, filed Sep. 27, 2002; the entire contents of this PCT application are incorporated by reference herein.

### BACKGROUND OF THE INVENTION

1. Field of the Invention

The invention relates to a composition for combating insects, acarides, mites and parasites causing health problems to humans and animals, such as birds.

2. The Prior Art

As stated in U.S. Pat. No. 3,980,784,“the control of animal parasites is one of the oldest and most important problems of the animal husbandry industry. Many types of parasites afflict virtually all species of animals. Most animals are afflicated by free-flying parasites such as flies, crawling ectoparasites such as lice and mites, burrowing parasites such as bots and grubs, and by microscopic endoparasites such as coccidia, as well as by larger endoparasites such as worms. Thus, the control of parasites even in a single host species is a complex and many-sided problem. The insect and acarina parasites which consume living tissues of a host animal are particularly harmful. The group includes parasites of all the economic animals, including ruminant and monogastric mammals and poultry, and of companion animals such as dogs as well.”

Up to now, insects, mites and parasites causing health problems to chicken, horses, . . . or humans are treated with chemical agents causing side effects, such as due to its release in water (river, pools, lakes, etc.), air, ground, soil, etc. causing environmental problems and causing problem for the health of the chicken, horses or humans.

Due to said side effects, legislation prevents the use of more and more insecticides, anti parasite compounds, etc.

Furthermore, due to the limited number of authorized insecticides, etc. (i.e. admitted by law), the insects and parasites become more and more resistant to said compounds, i.e. said compounds begin to be inefficient against insects and parasites.

It has already been proposed (U.S. Pat. No. 4,169,069) to use SiO2 particles with a particle size of 10 to 500 μm, as suitable porous inert carrier for active agent and to coat said particles with a polysiloxane, so as to delay the release of the active agent. Insecticide needs an immediate action and not a delayed action.

It has also been proposed (U.S. Pat. No. 4,678,774) to combine avermectin with a uncoated hydrophilic amorphous silicon dioxide, so as to enhance the insecticidal activity of avermectin. As stated in said document hydrophilic amorphous silicon dioxide has no insecticidal effect. Tests made by applicants have confirmed that uncoated hydrophilic silicon dioxide had no effect for killing parasites.

It has still been proposed (U.S. Pat. No. 4,945,088) to prepare insecticidal wettable powder prepared by mixing calcined white carbon with a insecticidal compound. The calcined white carbon particles have a size not less than 10 μm and is used as carrier for avoiding an oil separation of the insecticide in an aqueous suspension.

It has now been observed that SiO₂ nanoparticles (free of insecticide compound) which are provided with a silicon containing coating, said coating being suitable for killing insects.

### BRIEF SUMMARY OF INVENTION

The present invention has for subject matter a composition for combating insects, acarides (or dust mites) and worms, said composition comprising at least as active agent coated siliceous containing particles, said particles having an average primary particle size of less than 100 nm, advantageously of less than 50 nm, preferably comprised between 5 and 40 nm, most preferably between 5 and 20 nm, whereby the coated siliceous containing particles are particles provided with a silicon containing coating. The outer coating of the particles or at least a portion of said outer coating is preferably different from a coating obtained by a simple hydrolysis of SiO₂ particles in presence of water or humidity.

The silicon containing coating is for example a hydrophilic coating or a hydrophobic coating containing at least carbon atom or a mixture thereof. Hydrophobic coating seems to be preferred. The hydrophilic coating or hydrophobic coating is advantageously the outer coating. Possibly the siliceous containing particles are provided with a hydrophilic coating and with a hydrophobic coating. Preferably, in this case the hydrophobic coating is the outer coating. The hydrophilic and/or hydrophobic active coating can be overcoated with a control release layer, such as a water soluble layer, an entero soluble layer, etc.

While it is still unclear how the composition is working, it appears that the hydrophobic character of the nanoparticles is of importance. It seems that the hydrophobic nanoparticles are acting on the health of the treated insects and acarides, as well as on the health of the eggs, larvae, pupae, nymphs, etc. of said insects and acarides, whereby avoiding the exponential population growth of the insects and acarides due to the hatching of the exponential number of insects' eggs and acarides'eggs.

Parasites in the meaning of the present specification means also fungus, bacterium, virus, etc.

The siliceous containing particles are for example, silicon dioxide, precipitated silica, fumed silica, silicates, bentonite, synthetic hydrated silicon dioxide, diatomaceous earth, attapulgite clay, montmorillonite clay, silica gel particles, zeolite (natural or synthetic), etc. Synthetic siliceous containing particles are preferred, as it enables a good control of the particle size. It has to be noted that the siliceous particles can form agglomerates and that the average primary particle size is the size of a particle of the agglomerate. Synthetic amorphous silicon dioxide, precipitated silica, fumed silica and pyrogenic synthetic amorphous silica are preferred as nanoparticles.

The siliceous containing nanoparticles have advantageously a SiO₂ content (based on the ignited material) greater than 50% by weight, preferably greater than 90%, most preferably greater than 95%, such as greater than 99%, or even more than 99.5%, for example 99.8% or more.

The siliceous containing particles before its coating may contain some other atoms, such as Ca, Mg, Al, Na, Ti, Fe, halogen atom. However, after ignition of the particles, the siliceous containing nanoparticles are substantially free of said compound.

The coating of the siliceous containing nanoparticles is very thin and represent generally less than 20% of the weight of the uncoated nanoparticles, for example between 3 and 10%. The coating is preferably complete, even if some result can be obtained with partial coating on nanoparticles.

Advantageously, the hydrophobic or hydrophilic coated siliceous particles (not ignited) have a SiO₂ content of at least 50% by weight, preferably of at least 70%, most preferably of at least 80%, such as more than 90% by weight.

According to a detail of an embodiment, the hydrophobic or hydrophilic coated siliceous particles have a BET surface area of at least 40 m²/g, such as more than 75 m²/g, advantageously of at least 100 m²/g, preferably of at least 150 m²/g.

The hydrophobic or hydrophilic coated siliceous particles have preferably a pH comprised between 1 and 13, advantageously between 3 and 13, preferably between 3.5 and 8.5, such as between about 4 and about 6, said pH being measured in a water/methanol medium (1 volume water/1 volume methanol) with a solid content of 4% by weight.

The hydrophobic or hydrophilic coated siliceous nanoparticles have advantageously a tapped density greater than 40 g/l, such as greater than 50 g/l, preferably greater than 75 g/l, most preferably greater than 100 g/l (density according to the norm DIN iso 787/XI, August 1983).

The hydrophobic or hydrophilic coated siliceous particles are advantageously siliceous particles provided with a functionalized silane or siloxane (or polysiloxane) coating or with an organofunctional silane or siloxane (or polysiloxane) coating.

Advantageously, the structure of the siliceous containing particles are modified before and/or during and/or after making the treatment, preferably after the coating treatment, most preferably after a drying step (before and/or during and/or after a curing step). For example, the agglomerated nanoparticles forming agglomerates are submitted to treatment for breaking the agglomerates, for example by milling, by micronizing, by ultrasound treatment, by lyophilization, by spraying, by grinding, by mixing in a bath or liquid medium (intensive mixing), and combinations thereof. Reference can be done to US20020077388 for disclosing a specific method for modifying the structure of silicas.

Advantageously, the hydrophobic or hydrophilic coated siliceous particles are provided with a hydrophobic silicon coating comprising at least carbon atoms and at least one or more atoms selected from the group consisting of P,S,O,N, Cl, F, I. For example, the hydrophobic silicon coating comprises at least one function selected from the group consisting of amino, ureido, thio, halogeno hydrocarbon group, cyano, isocyanato, and mixture thereof. Specific possible examples of coatings are: substituted or unsubstituted silane esters, substituted or unsubstituted vinyl silane, substituted or unsubstituted methacryloxysilane, substituted or unsubstituted epoxysilane, substituted or unsubstituted sulfur silane, substituted or unsubstituted sulfur siloxane or polysiloxane, mercapto silane or siloxane or polysiloxane, substituted or unsubstituted amino silane, ureido silane, isocyanato silane, substituted or unsubstituted chlorinated silane, substituted or unsubstituted fluorinated silane, substituted or unsubstituted polyalkoxy or polyorganoalkoxysiloxanes, disilazanes (such as hexamethyldisilazane), and mixtures thereof.

### DETAILED DESCRIPTION OF THE INVENTION

According to a specific embodiment, the composition for combating insects, acarides, mites, ticks and parasites, comprises at least as active agent:

Active siliceous containing particles, said particles having an average primary particle size of less than 100 nm, advantageously of less than 50 nm, preferably comprised between 5 and 40 nm, whereby the siliceous containing particles are provided with a hydrophilic silicon containing coating, advantageously with an outer hydrophilic silicon containing coating, and

Active siliceous containing particles, said particles having an average primary particle size of less than 100 nm, advantageously of less than 50 nm, preferably comprised between 5 and 40 nm, whereby the siliceous containing particles are provided with a hydrophobic silicon containing coating, advantageously with an outer hydrophobic silicon containing coating, the weight ratio active siliceous containing particles with a (outer) hydrophilic silicon containing coating/active coated siliceous containing particles with a (outer) hydrophobic silicon containing coating being comprised between 1/100 and 100/1, advantageously between 1/50 and 1/2, preferably between 1/50 and 1/1.

The invention relates also to a composition for combating insects, aracides, mites, ticks and parasites, said composition comprising at least as active agent coated siliceous containing particles, said particles having an average primary particle size of less than 100 nm, advantageously of less than 50 nm, preferably comprised between 5 and 40 nm, whereby the coating comprises a portion which is a hydrophilic silicon containing coating and another portion which is a hydrophobic silicon containing coating.

In the composition of the invention, the hydrophobic coating or the hydrophilic coating forms an outer coating of the siliceous containing particles.

According to a possible embodiment, the (outer) hydrophobic coating or the (outer) hydrophilic coating is overcoated with a water soluble layer or an entero soluble layer.

Compositions of the invention show activity against a number of insects, acarides, mites, ticks and various endo and ecto parasites, especially blood sucking parasites, ants, fleas, ticks, lynes, termites, bugs, beetles, springtails, gnaks, etc.

More specifically, compositions of the invention show activity against members of the insect order Lepidoptera such as the beet armyworm, tobacco budworm, codling moth and cabbage looper. Other typical members of this order include the southern armyworm, cutworms, clothes moths, Indian meal moth, leaf rollers, corn earworm, cotton bollworm, European corn borer, imported cabbage worm, pink bollworm, bagworms, Eastern tent caterpillar, sod webworm, and fall armyworm.

Compositions of the invention also show activity against members of the order Coleoptera (the beetles and weevils such as the Colorado potato beetle, spotted and striped cucumber beetles, Japanese beetle, and boll weevil) and Diptera (the true flies such as the house fly, mosquitoes, fruit flies, stable and horn flies, and leaf miners).

Compositions of the invention also show activity against members of the order Hempitera (true bugs such as plant bugs, stink bugs, and chinch bugs), Homoptera (such as the aphids, leafhoppers, planthoppers, whiteflies, scales, and mealybugs), Mallophaga (chewing lice), Anoplura (sucking lice), house dust, mites, dust mites, scabies mite (sarcoptes scabier) book worms, schurft mites, fruit fly, fruit worms, leave lices, Thysanoptera (thrips), Orthoptera (such as cockroaches, grasshoppers, and crickets), Siphonaptera (fleas), Isoptera (termites), and members of the Hymenoptera order Formicidae (ants), as well as the eggs, larvae and/or purpae and/or nymphs thereof.

Compositions of the invention shows activity against mites and ticks of the order Acari, for example, the two-spotted spider mite. Other typical members of this order include plant parasites such as the citrus red mite, European red mite, and citrus flat mite, and animal parasites such as the mange mite, scab mite, sheep scab mite, chicken mite, scalyleg mite, depluming mite and dog follicle mite.

Specific representative antrhopod pests which can be controlled by the composition of the invention include the following: Amblyomma americanum (Lone-star tick), Amblyomma maculatum (Gulf Coast tick), Argas persicus (fowl tick), Boophilus microplus (cattle tick), Chorioptes spp. (mange mite), Demodex bovis (cattle follicle mite), Demodex canis (dog follicle mite), Dermacentor andersoni (Rocky Mountain spotted fever tick), Dermacentor variabilis (American dog tick), Dermanyssus gallinae (chicken mite), Ixodes ricinus (common sheep tick), Knemidokoptes gallinae (deplumming mite), Knemidokoptes mutans (scalyleg mite), Otobius megnini (ear tick), Psorop ovis (scab mite), Rhipicephalus sanguineus (brown dog tick), Sarcoptes scabiei (mange mite), Aedes(mosquitoes), Anopheles (mosquitoes), Culex (mosquitoes), Culiseta, Bovicola bovis (cattle biting louse), Callitroga homnivorax (blowfly), Chrysops spp. (deer fly), Cimex lectularius (bed bug), Cochliomyia spp. (screwworm), Ctenocephalides canis (dog flea), Ctenocephalides felis (cat flea), Culicoides spp. (midges, sandflies, punkies, or no-see-ums), Damalinia ovis (sheep biting louse), Dermatobia spp. (warble fly), Gasterophilus haemorrhoidalis (nose hot fly), Gasterophilus intestinalis (common horse bot fly), Gasterophilus nasalis (chin fly), Glossina spp. (tsetse fly), Haematobia irritans (horn fly, buffalo fly), Haematopinus asini (horse sucking louse), Haematopinus eurysternus (short nosed cattle louse), Haematopinus ovillus (body louse), Haematopinus suis (hog louse), Hydrotaea irritans (head fly), Hypoderma bovis (bomb fly), Hypoderma lineatum (heel fly), Linognathus ovillus (body louse), Linognathus pedalis (foot louse), Linognathus vituli (long nosed cattle louse), Lucilia spp. (maggot fly), Melophagus ovinus (sheep ked), Musca spp. (house fly, face fly), Oestrus ovis (nose bot fly), Pediculus spp. (lice), Phlebotomus spp. (sandfly), Phormia regina (blowfly), Psorophora spp. (mosquito), Pthirus spp. (lice), Reduvius spp. (assassin bug), Simulium spp. (black fly), Solenopotes capillatus (little blue cattle louse), Stomoxys calcitrans (stable fly), Tabanus spp. (horse fly), Tenebrio spp. (mealworms), Triatoma spp. (kissing bugs).

More specific parasites which can be combated with compositions of the invention are:

Parasites of Horses:

horsefly, adult, bloodsucking, as well as their larvae and pupae

stable fly, adult, bloodsucking, as well as their larvae and pupae

black fly, adult, bloodsucking, as well as their larvae and pupae

horse sucking louse, immature, adult, bloodsucking, as well as their larvae and pupae

mange mite, nymph, adult, skin-burrowing, as well as their larvae and pupae

scab mite, adult, skin-eating, as well as their larvae and pupae

common horse bot fly, larva, migrating in alimentary canal, as well as their larvae and pupae

chin fly, larva, migrating in alimentary canal, as well as their larvae and pupae

nose bot fly, larva, migrating in alimentary canal, as well as their larvae and pupae

Parasites of Bovines

horn fly, adult, bloodsucking, as well as their larvae and pupae

cattle biting louse, adult, skin-eating, as well as their larvae and pupae

cattle bloodsucking louse, nymph, adult, bloodsucking, as well as their larvae and pupae

tsetse fly, adult, bloodsucking, as well as their larvae and pupae

stable fly, adult, bloodsucking, as well as their larvae and pupae

horse fly, adult, bloodsucking, as well as their larvae and pupae

cattle follicle mite, adult, skin-burrowing, as well as their larvae and pupae

cattle tick, larva, nymph, adult, bloodsucking, as well as their larvae and pupae

ear tick, nymph, bloodsucking, as well as their larvae and pupae

Gulf Coast tick, adult, bloodsucking, as well as their larvae and pupae

Rocky Mountain spotted-fever tick, adult, bloodsucking, as well as their larvae and pupae

lone star tick, adult, bloodsucking, as well as their larvae and pupae

heel fly, larva, migrating through the body, as well as their larvae and pupae

bomb fly, larva, migrating through the body, as well as their larvae and pupae

blowfly, larva, infesting wounds, as well as their larvae and pupae

assassin bug, adult, bloodsucking, as well as their larvae and pupae

Parasites of Swine, as well as their larvae and pupae

hog louse, nymph, adult, bloodsucking, as well as their larvae and pupae

chigoe flea, adult, bloodsucking, as well as their larvae and pupae

Parasites of Sheep and Goats:

bloodsucking body louse, adult, bloodsucking, as well as their larvae and pupae

bloodsucking foot louse, adult, bloodsucking, as well as their larvae and pupae

sheep ked, adult, bloodsucking, as well as their larvae and pupae

sheep scab mite, nymph, adult, skin-eating, as well as their larvae and pupae

nose fly, larva, migrating in the sinuses, as well as their larvae and pupae

greenbottle fly, larva, infesting wounds, as well as their larvae and pupae

black blowfly, larva, infesting wounds, as well as their larvae and pupae

secondary screwworm, larva, infesting wounds, as well as their larvae and pupae

Parasites of Poultry:

bed bug, nymph, adult, bloodsucking, as well as their larvae and pupae

Southern chicken flea, adult, bloodsucking, as well as their larvae and pupae

fowl tick, nymph, adult, bloodsucking, as well as their larvae and pupae

chicken mite, nymph, adult, bloodsucking, as well as their larvae and pupae

scaly-leg mite, adult, skin-burrowing, as well as their larvae and pupae

depluming mite, adult, skin-burrowing, as well as their larvae and pupae

Parasites of Dogs:

horse fly, adult, bloodsucking, as well as their larvae and pupae

stable fly, adult, bloodsucking, as well as their larvae and pupae

mange mite, nymph, adult, skin-burrowing, as well as their larvae and pupae

dog follicle mite, adult, burrowing in hair follicles, as well as their larvae and pupae

flea, adult, bloodsucking, as well as their larvae and pupae

It will be understood that the parasites mentioned above are not confined to the single host animal with which each is here identified. Most parasites inhabit various hosts, although each parasite has a favorite host. For example, the mange mite attacks at least horses, hogs, mules, humans, dogs, cats, foxes, rabbits, sheep, and cattle. Horseflies freely attack horses, mules, cattle, hogs, dogs, and most other animals. My method effectively kills parasites of the types described above growing in the host animals mentioned above, and in other host animals as well. For example, my invention is effective in cats, camels, and zoo animals, etc.

The composition of the invention can also be used for treating plants, such as fruit trees, vegetable, house plants, flowers, trees, spire, or portion thereof, such as fruits, etc.

The composition of the invention which is already effective when comprising only the hydrophobic coated siliceous nanoparticles, can if required further comprises one or more elements selected from the group consisting of:

compounds suitable for attracting the insect or acarides or ticks or parasites or mites to be combated, such as food, sugar, beer, tartaric acid, honey, blood concentrates, fruit syrups, butter acid, carbon dioxide, etc.

insecticide compounds, such as chlorinated or fluorinated compounds;

solvents, such as aliphatic alcohols, such as water, non polar solvents, such organic solvents, hexane, heptane, terpene, benzene, isoprene, isopar, thinner, methanol, ethanol, isopropylalcohol, ketones, acetone, methyl ethyl ketone, glycol, polyethylene glycol, propyleneglycol, dimethylformamide, dimethyl sulfoxide, acetonitrile, glycol ethers, methylol, dioxalane, polypropylene carbamate,.esters, ethers, halogeno solvent, for example chlorinated solvents, such as chlorinated hydrocarbons, 1,2,2 trichloro- 1,1,2- trifluoroethane, fluorinated solvents, such as fluorinated hydrocarbons, hydrofluoroethers, mixtures thereof. Typical examples are perfluorohexane, perflorooctane, pentafluorobutane, CF₃CFHFHCF₂CF₃, methylperfluoroethers, ethyl perfluorobutyl ether, trifluoromethyl-3-ethoxydodécafluorhexane, ethyl nonafluoro isobutylether, methyl nonafluoro butyl ether, and mixtures thereof. Preferred fluoro solvents are trifluoromethyl-3-ethoxydodécafluorhexane, ethyl nonafluoro isobutylether, ethyl nonafluoro butylether, methyl nonafluoro butyl ether, methyl nonafluoro isobutyl ether and mixtures thereof.

surfactant and tensioactive agents, such as ammonium, phosphonium, betaine, soap, amidobetaine, sulfonated lignins, the condensed naphthalenesulfonates, the naphthalenesulfonates, the alkylbenzenesulfonates, the alkyl sulfates, and nonionic surfactants such as ethylene oxide adducts of alkyl phenols

germicide,

antibacterial agent,

herbicides,

growth inhibitor or regulator, chitin inhibitors, hormone, pheromone,

anti algae,

antifungal agents,

disintegrant,

solid inert particles, such as calcium carbonate, uncoated silicon dioxide, silicon dioxide, precipitated silica, fumed silica, silicates, bentonite,, synthetic hydrated silicon dioxide, diatomaceous earth, attapulgite clay, montmorillonite clay, silica gel particles, zeolite (natural or synthetic), etc

acidifying means or buffer agents,

chelating agents, water retention agent (polyacrylamide, bentonite, zeolite),

gums, polysaccharide, cellulose, and their derivatives, and

mixtures thereof

The composition of the invention is however substantially free of any additives, except of compounds suitable for attracting the parasites to be killed or combated and inert solid particles. The composition of the invention is advantageously in the form of a powder or in the form of a suspension or in the form of a suspension of siliceous containing particles in a solvent for the coating agent or in the form of granules or pellets or in the form of food additives or in the form of a gel or in the form of colloidal medium. When given as food additives to the animals to be protected from the parasites, the parasites present in the digestive path of the animal are combated, while as after its passage in the digestive path, the hydrophobic compound will be released in the excrement, the hydrophobic compound will be active against parasites living in said excrement or lying eggs in said excrement.

The composition of the invention can be applied on the animals or a portion of the animals to be treated. For example, the composition of the invention can be applied on the animal or on a surface where insects or acarides or parasites have to be killed, by powdering a dry composition, by spraying a dry or liquid composition, by brushing or painting a dry or liquid composition, rolling the animal or a portion thereof in a dry or liquid bath, by obliging the animal to pass on a dry or liquid bath, by feeding the animal with an aqueous or non aqueous composition or suspension, by dipping the animal or a portion thereof in an aqueous or non aqueous composition, by electrostatic application of the powder on a support, by blowing powder, etc. with or without ultrasonic support, and with or without fluidized bed.

The composition can contain particles with a larger particle size. However, the active agent will preferably not contain more than 50% by weight (preferably no more than 10%) of coated siliceous containing particle with an average primary particle size of more than 100 nm, said percentage being calculated on basis of the weight of active particles with an average primary size of less than 100 nm. The weight ratio active coated siliceous containing nanoparticles/filler and additives is for example comprised between 0.001 and 1000, such as between 0.01 and 100, for example between 0.05 and 20.

The composition of the invention, in dry or liquid forms, can be used in many possible application, such as:

farming applications, for example in poultry, for treating horse, cowshed, etc.

in cosmetic fields, such as for treating hairs, as for example as shampoo, soaps, gel, shower gel, etc.

food, as for poultry, horses, cows, etc.

in household fields, such as for treating carpets, beds, mattress, curtains, textiles, clothes, napkins, etc., the treatment can be made as a dry treatment (dry cleaning) or a wet treatment or a semi dry cleaning, with or without other additives such as washing agents, with or without heat, with or without water vapor, according to an advantageous embodiment, after treating the surface or the object, the composition and the dead insects or acarides or parasites are sucked in a sucking device or a vacuum cleaner,

for treating plants, such as interior plants as exterior plants, such as flowers, grapes, trees, fruit trees, vegetable,

for treating rooms and chamber and confined spaces, such as TV boxes, computer boxes,

for treating grounds or soils or garbage,

for removing from the skin (human skin, animal skin, etc.) bloodsucking parasites;

in pharmaceutical composition for keeping parasite away,

in packaging, for example in closing means, such as reclosable cork or stopper,

etc.

The invention relates also to a process for combating insects, mites, ticks, parasites, especially blood sucking parasites, in which the insects, mites, ticks or parasites are contacted with a composition of the invention, especially with a composition comprising siliceous containing particles with an outer hydrophobic coating, and/or in which the eggs, larva, pupae, nymphs, etc. of the insects, mites, ticks, parasites to be combated are contacted with a composition of the invention.

A further object of the invention is a process for preventing troubles to animals or humans due to insects, mites, ticks and parasites, especially bloodsucking parasites, in which a composition of the invention is applied on at least a portion of the skin or the hair or the leather or scalp or feather of the human or animal

The invention also relates to a support provided with a composition of the invention, said support being for example: foods, cosmetic composition, pharmaceutical composition, packaging, animals or portions thereof, humans and portion thereof, plants and portions thereof, buildings and portions thereof, grounds, soils, plastic, carpets, furniture, springs, mattress and portion thereof, tissues (woven or non woven), fabrics (woven or non woven), cushions, garments, clothes, metals, recipients, closing means, filter, bands, feather, leather, hair, etc. and mixtures thereof.

As the coated particles of the composition of the invention are not degraded at temperature below 200° C., the particles have a very long time efficiency, as long as there are sufficient particles present for treating the insect, ticks, mites and parasites.

The invention relates also to a process for coating siliceous containing particles dispersed in a medium so as to form a colloidal medium with a weight solid content greater than 25%, advantageously greater than 40%, preferably greater than 50%, most preferably greater than 60%, in which a silicon containing coating agent is added to the medium, in which after coating the particles, the medium is dried. The so obtained coated particles are advantageously treated so as to modify the structure of the coated particles. Advantageously, the structure of the siliceous containing particles are modified before and/or during and/or after making the coating treatment, preferably after the coating treatment, most preferably after a drying step (before and/or during and/or after a curing step). For example, the agglomerated nanoparticles forming agglomerates are submitted to treatment for breaking the agglomerates, for example by milling, by micronizing, by ultrasound treatment, by lyophilization, by spraying, by grinding, by mixing in a bath or liquid medium (intensive mixing), and combinations thereof. Reference can be done to US20020077388 for disclosing a specific method for modifying the structure of silicas.

The colloidal medium is advantageously a water free colloidal medium or a substantially water free, and preferably a medium suitable for solubilizing the coating agent. Such a medium is for example alcohols, ethanol, methanol, fluoro solvents, etc., mixtures thereof. The colloidal medium can comprise one or more stabilizers, such as alkali, ammonium hydroxide, sodium hydroxide, potassium hydroxide, lithium hydroxide, triethylamine, dimethylethanol, glycol, ethyleneglycol, diethyleneglycol, dimethylethanol amino,etc. and mixtures thereof.

### EXAMPLES

### Example 1

In said tests, bloodsucking chicken parasites (red blood lice, which was found in industrial laying hen houses) were placed in transparent boxes of 1 liter. The parasites were treated with a various powdered compositions, namely:

(uncoated SiO₂)uncoated silicon dioxide particle with an average primary particle size of about 20 nm;

Al₂O₃ particles;

TiO₂ particles;

Hydrophobic coated silicon dioxide particles with a BET surface of 160 m²/g, an average primary particle size of 10 nm, and a carbon content of about 3% (due to the coating) (AEROSIL R 8200—Degussa)

Hydrophobic coated silicon dioxide particles with a BET surface of 260 m²/g, an average primary particle size of 7 nm, and a carbon content of about 3% (due to the coating) (AEROSIL R 812—Degussa)

Hydrophobic coated silicon dioxide particles with a BET surface of 150 m²/g, an average primary particle size of 12 nm, and a carbon content of about 5% (due to the coating) (AEROSIL R 805—Degussa)

Structure modified and with a methacrylsilane after treated fumed silica (AEROSIL R 7200 Degussa) with a BET surface of about 150 m²/g, a carbon content of about 5%, a tapped density of about 230 g/l, a pH (4% by weight dispersion) of about 5, and an average primary particle size of about 10 to 15 nm

In each boxes containing some parasites, an amount of powder was placed for covering 50% of the bottom surface of the box.

Results of the tests is given in the following table:

| | Activity of the parasites after | | | | |
|---|---|---|---|---|---|
| Product | 10 minutes | 3 hours | 5 hours | 7 hours | 9 hours |
| Reference | +++ | +++ | +++ | +++ | +++ |
| no treatment | | | | | |
| Uncoated | +++ | +++ | +++ | +++ | +++ |
| SiO₂ | | | | | |
| Al₂O₃ | +++ | +++ | +++ | +++ | +++ |
| TiO₂ | +++ | +++ | +++ | +++ | +++ |
| Aerosil R 8200 | + | + | +/− | dead | dead |
| Aerosil R 812 | + | + | +/− | dead | dead |
| Aerosil R 805 | + | + | +/− | dead | dead |
| Aerosil R 7200 | + | dead | dead | dead | dead |

+++: very active
+: active
+/−: substantially no activity
dead: all the parasites are dead

As it can be seen from these tests, the composition of the invention had a good efficiency for killing after a reasonable treatment period the parasites.

### Example 2

Aerosil R 805 was powdered on a portion of a hen house (the powdering being repeated twice a month), so that some laying hens are treated while some other hen were not treated.

It appears from a long term use (more than 12 months) that the treated laying hens had a better health (no dead hens were observed for the treated laying hens, while some dead hens were observed for the non treated hens), and that the eggs of the treated laying hens were substantially not spotted due to the parasites.

No trace of aerosil 805 were found in the eggs of the treated hens.

### Example 3

Example 2 was repeated, except that an alcohol dispersion of Aerosil R 7200 was sprayed in the hen house, with the hens present.

### Example 4

Example 3 was repeated, except that the treatment was made in the hen house after removing the hens. The treatment was thus made as a preventive treatment.

### Example 5

A commercial shampoo was mixed with aerosil R 7200 particles, so that the particle content of the composition was 5% by weight. It has been observed that the presence of the particles had a small abrading effect during the friction of the shampoo on the hair and that after treatment, all the lice were removed. It has also been observed that some aerosil powder was remaining on the hair, whereby forming a preventing agent against lice.

In the same way a dry shampoo was prepared by adding 5% by weight of Aerosil 7200 in a commercial dry shampoo composition.

### Example 6

A dog with ticks was treated with a glove filled with aerosil 7200 powder. After swabbing the skin of the dog with the glove, the dog was left with the powder for 4 hours. The dog was thereafter brushed so as to remove dead ticks.

The so treated dog had a better resistance against ticks and flea, this being probably due to the presence of some aerosil 7200 dust particles.

### Example 7

A plant colonized with plant louse was treated with a dry spray of aerosil 7200. Three hours after the treatment, the plant louse were killed.

### Example 8

A food flour for chicken was mixed with Aerosil 7200, so that the Aerosil 7200 content was 1%. It has been observed that less lice were present on the dejection of the chicken eating the food flour with the additive, than on the dejection of the chicken not eating the food flour with the additive.

### Example 9

100 g of sugar powder was mixed with 10 g Aerosil 7200 so as to form a mixture suitable for attracting parasite.

### Example 10

An ant nest has been treated with dry powder Aerosil 7200. After three hours, the ants were dead.

### Example 11

A carpet has been treated with a dry powder formulation containing 50% by weight Aerosil 7200. After three hours, the house dust mites were dead. After vacuum cleaning, some aerosil 7200 particles were remaining in the carpet, whereby forming a preventing agent against house dust mites.

### Example 12

Example 11 was repeated except that the formulation comprised substantially only Aerosil 7200.

### Example 13

A garment (such as a head band, a hood, helmet, beret, balaclava,gloves, cover, etc) were dry treated with aerosil 7200 powder. The so treated garment had a preventive effect against parasite.

### Example 14

Example 13 was repeated, except that they were washed with a washing powder comprising 10% by weight of aerosil 7200.

### Example 15

Functionalized Hydrophobic SiO₂ Particles Have Been Prepared as Follows:

SiO₂ particles have been placed in ethanol so as to form a SiO₂ suspension with a SiO₂ content of 5% by weight. Fluor ammonium silane (produced by 3M) was added to the SiO₂ suspension. The amount of fluor ammonium silane added was equal to 0.1% of the solid weight of the suspension. Ethanol is a solvent for the fluor ammonium silane. (other solvents, such as fluoro solvents can be used). After 30 minutes, the SiO₂ particles provided with a functionalized hydrophobic coating were dried and treated so as to modify the structure of the coated particles. Said structure modification was carried out by intensive mixing After said treatment (structure modification), the average particle size of the coated SiO₂ particles was about 7-10 nm.

Functionalized Hydrophobic SiO₂ Particles with a Silanol Layer

SiO₂ particles have been placed in hot water during 10 minutes so as to ensure the formation of a silanol layer at the outer face of the SiO₂ particles. After drying at 100-105° C., the particles have been treated with fluor ammonium silane in ethanol as disclosed here above.

Functionalized Hydrophilic SiO₂ Particles Have Been Prepared as Follows:

SiO₂ particles have been placed in ethanol so as to form a SiO₂ suspension with a SiO₂ content of 5% by weight. 4-Amino-3,3-dimethyltrimethoxysilane was added to the SiO₂ suspension. The amount of added silane was equal to 0.1% of the weight of the suspension. After 30 minutes, the SiO₂ particles provided with a functionalized hydrophilic coating were dried and treated in a ball mill. The average particle size of the coated SiO₂ particles was about 10 nm.

Functionalized Hydrophobic Colloid SiO₂ Particles I Have Been Prepared as Follows:

A colloidal medium consisting of colloidal SiO₂ particles in ethanol with a solid content of 60% by weight have been treated with fluoro ammonium silane. The amount of fluoro ammonium silane added was equal to 0.1% of the solid weight of the colloidal medium. Ethanol is a solvent for the fluoro ammonium silane. (other solvents, such as fluoro solvents can be used). After 30 minutes, the colloidal medium was dried so as to obtain SiO₂ particles provided with a functionalized hydrophobic coating. The particles were treated so as to modify the structure of the coated particles. Said structure modification was carried out by intensive mixing. After said treatment (structure modification), the average particle size of the coated SiO₂ particles was lower than 10 nm.

Functionalized Hydrophobic Colloid SiO₂ Particles II Have Been Prepared as Follows:

A colloidal medium consisting of colloidal SiO₂ particles in ethanol with a solid content of 60% by weight, said medium comprising a stabilizer (such as triethylamine) have been treated with fluoro ammonium silane. The amount of fluoro ammonium silane added was equal to 0.1% of the solid weight of the colloidal medium. Ethanol is a solvent for the fluoro ammonium silane. (other solvents, such as fluoro solvents can be used). After 30 minutes, the colloidal medium was dried so as to obtain SiO₂ particles provided with a functionalized hydrophobic coating. The particles were treated so as to modify the structure of the coated particles. Said structure modification was carried out by ball milling.

After said treatment (structure modification), the average particle size of the coated SiO₂ particles was lower than 10 nm.

These particles have been used for treating (combating) blood sucking mites active for chicken and hens. Said blood sucking mites have been placed in boxes. The treatment was made by adding to each box an amount of composition to be tested sufficient for having a substantially complete covering of the bottom of the box.

The compositions used in said example are:

Composition I: funtionalized hydrophobic SiO2 particles

Composition II: funtionalized hydrophilic SiO2 particles

Composition III: 50% by weight funtionalized hydrophobic SiO2 particles+50% by weight funtionalized hydrophilic SiO2 particles

Composition IV: 10% by weight funtionalized hydrophobic SiO2 particles+90% by weight funtionalized hydrophilic SiO2 particles

Composition V: 50% by weight funtionalized hydrophobic SiO2 particles+50% by weight SiO2 particles not provided with a functionalized coating (SiO2 particle with a silanol coating prepared by surface hydrolysis)

Composition VI: Functionalized hydrophobic SiO₂ particles with an inner silanol layer

Composition VII: SiO₂ particles with an outer silanol layer (hydrolysis)

Composition VIII:Functionalized hydrophobic colloid SiO₂ particles I

Composition IX: Functionalized hydrophobic colloid SiO₂ particles II

Results of the tests are given in the following table.

Activity of the blood sucking mites after a period of treatment of (Time)

| Time | 10 minutes | 1 hour | 3 hour | 5 hour |
|---|---|---|---|---|
| Composition I | + | +/− | dead | dead |
| Composition II | + | +/− | +/− | dead |
| Composition III | + | +/− | dead | dead |
| Composition IV | + | +/− | dead | dead |
| Composition V | + | +/− | dead | dead |
| Composition VI | + | +/− | dead | dead |
| Composition VII | + | + | + | + |
| Composition VIII | + | +/− | dead | dead |
| Composition IX | + | +/− | dead | dead |

+: active
+/−: reduced activity
dead: no activity

What we claim is:

1. Composition for combating insects, acarides, mites, ticks and parasites, said composition comprising at least as active agent coated siliceous containing particles, said particles having an average primary particle size of less than 100 nm, whereby the coating is a hydrophobic silicon containing coating.

2. The composition of claim 1, which comprises coated siliceous particles provided with an outer hydrophobic silicon containing coating.

3. The composition of claim 1, which comprises coated siliceous containing particles, said particles having an average primary particle size of less than 50 nm, whereby the coating is a hydrophobic silicon containing coating.

4. The composition of claim 1, which comprises coated siliceous containing particles, said particles having an average primary particle size comprised between 5 and 40 nm, whereby the coating is a hydrophobic silicon containing coating.

6. The composition of claim 1, in which the coated siliceous particles have a SiO₂ content of at least 50% by weight.

7. The composition of claim 1, in which the coated siliceous particles have a SiO₂ content of at least 80% by weight.

8. The composition of claim 1, in which the coated siliceous particles have a BET surface area of at least 40 m²/g.

9. The composition of claim 1, in which the coated siliceous particles have a BET surface area of at least 100 m²/g.

10. The composition of claim 1, in which the hydrophobic silicon containing coating comprises at least an element selected from the group consisting of functionalized silanes, siloxane and mixtures thereof.

11. The composition of claim 1, in which the hydrophobic silicon containing coating comprises at least carbon atoms and at least one or more atoms selected from the group consisting of P,S,O,N, Cl, F, I.

12. The composition of claim 1, in which the hydrophobic silicon containing coating comprises at least one function selected from the group consisting of amino, ureido, thio, halogeno hydrocarbon group, cyano, isocyanato, mercapto, disilazane, acrylic, methacrylic and mixtures thereof.

13. The composition of claim 1, which further comprises one element selected from the group consisting of compounds suitable for attracting the insect or worm or acaride or mites or ticks to be combated, insecticide compounds, solvents, dispersant, tensioactive, surfactant, germicide, antibacterial agent, herbicides, growth regulators, chitin inhibitor, antifungal agents, disintegrant, antialgae, hormones, chelating agents, water retention agent, food, and mixtures thereof

14. The composition of claim 1, which is in a form selected from the group consisting of a powder, a suspension, granules, pellets, food additives, gel, colloidal medium and combinations thereof.

15. The composition of claim 1, which comprises at least one compound selected from the group consisting of additives and fillers, the weight ratio active siliceous containing nanoparticles coated with a hydrophobic coating/compound selected from the group consisting of additive and filler being comprised between 0.001 and 1000.

16. The composition of claim 1, which comprises at least one compound selected from the group consisting of additives and fillers, the weight ratio active siliceous containing nanoparticles coated with a hydrophobic coating/compound selected from the group consisting of additive and filler being comprised between 0.01 and 100.

17. The composition of claim 1, which comprises at least one compound selected from the group consisting of additives and fillers, the weight ratio active siliceous containing nanoparticles coated with a hydrophobic coating/compound selected from the group consisting of additive and filler being comprised between 0.05 and 20.

18. The composition of claim 1, in which the hydrophobic coating is overcoated with an outer layer selected from the group consisting of water soluble layers, entero soluble layers and combinations thereof.

19. The composition of claim 1, in which the siliceous containing particles are provided with at least a hydrophilic silicon containing coating and with at least a hydrophobic silicon containing coating.

20. The composition of claim 1, in which the coated siliceous containing particles are coated particles with a modified structure.

21. Composition for combating insects, acarides, mites, ticks and parasites, said composition comprising at least as active agent coated siliceous containing particles, said particles having an average primary particle size of less than 100 nm, whereby the coating is a hydrophilic silicon containing coating.

22. The composition of claim 21, which comprises at least as active agent coated siliceous containing particles, said particles having an average primary particle size of less than 50 nm, whereby the coating is a hydrophilic silicon containing coating.

23. The composition of claim 21, which comprises at least as active agent coated siliceous containing particles, said particles having an average primary particle size comprised between 5 and 40 nm, whereby the coating is a hydrophilic silicon containing coating.

24. The composition of claim 21, which comprises siliceous containing particles coated with a hydrophilic silicon containing coating.

25. The composition of claim 21, in which the hydrophilic coating is overcoated with an outer layer selected among the group consisting of water soluble layers, entero soluble layers and combinations thereof.

26. The composition of claim 21, in which the siliceous containing particles are provided with at least a hydrophilic silicon containing coating and with at least a hydrophobic silicon containing coating.

27. The composition of claim 21, in which the coated siliceous containing particles are coated particles with a modified structure.

28. Composition for combating insects, acarides, mites, ticks and parasites, said composition comprising at least as active agent coated siliceous containing particles, said particles having an average primary particle size of less than 100 nm, whereby the coating comprises a portion which is a hydrophilic silicon containing coating and another portion which is a hydrophobic silicon containing coating.

29. The composition of claim 28, which comprises coated siliceous containing particles, said particles having an average primary particle size of less than 100 nm and being provided with an outer coating comprising a portion which is a hydrophilic silicon containing coating and another portion which is a hydrophobic silicon containing coating.

30. The composition of claim 28, which comprises at least as active agent coated siliceous containing particles, said particles having an average primary particle size of less than 50 nm, whereby the coating comprises a portion which is a hydrophilic silicon containing coating and another portion which is a hydrophobic silicon containing coating.

31. The composition of claim 28, which comprises at least as active agent coated siliceous containing particles, said particles having an average primary particle size comprised between 5 and 40 nm, whereby the coating comprises a portion which is a hydrophilic silicon containing coating and another portion which is a hydrophobic silicon containing coating.

32. The composition of claim 28, in which the coating selected from the group consisting of hydrophobic coating and hydrophilic coating is overcoated with an outer layer selected from the group consisting of water soluble layers, entero soluble layers and combinations thereof.

33. The composition of claim 28, in which the coated siliceous containing particles are coated particles with a modified structure.

34. Composition for combating insects, acarides, mites, ticks and parasites, said composition comprising at least as active agent:
coated siliceous containing particles, said particles having an average primary particle size of less than 100 nm, whereby the coating is a hydrophilic silicon containing coating, and
coated siliceous containing particles, said particles having an average primary particle size of less than 100 nm, whereby the coating is a hydrophobic silicon containing coating,
the weight ratio active siliceous containing particles with hydrophilic silicon containing coating/active coated siliceous containing particles with hydrophobic silicon containing coating being comprised between 1/100 and 100/1.

35. The composition of claim 34, which comprises:
coated siliceous containing particles, said particles having an average primary particle size of less than 50 nm, whereby the coating is a hydrophilic silicon containing coating, and
coated siliceous containing particles, said particles having an average primary particle size of less than 50 nm, whereby the coating is a hydrophobic silicon containing coating,
the weight ratio active siliceous containing particles with hydrophilic silicon containing coating/active coated siliceous containing particles with hydrophobic silicon containing coating being comprised between 1/50 and 2/1.

36. The composition of claim 34, which comprises at least as active agent:
coated siliceous containing particles, said particles having an average primary particle size of less than 100 nm, whereby the outer coating is a hydrophilic silicon containing coating, and
coated siliceous containing particles, said particles having an average primary particle size of less than 100 nm, whereby the outer coating is a hydrophobic silicon containing coating,
the weight ratio active siliceous containing particles with a outer hydrophilic silicon containing coating/active coated siliceous containing particles with an outer hydrophobic silicon containing coating being comprised between 1/100 and 100/1.

37. A support provided with at least one composition comprising at least as active agent for combatting insects, acarides, mites, ticks and parasites, coated siliceous containing particles, said particles having an average primary particle size of less than 100 nm, whereby the coating is a hydrophobic silicon containing coating.

38. The support of claim 37, which is selected from the group consisting of animals or portions thereof, humans and portion thereof, plants and portions thereof, buildings and portions thereof, grounds, soils, plastic, carpets, furniture, springs, mattress and portion thereof, tissues, fabrics, cushions, garments, clothes, metals, recipients, closing means, filter, bands, feather, leather, hair, and combinations thereof.

39. Process for combating insects, acarides, mites, ticks and parasites, in which at least one living organism selected from the group consisting of insects to be combated, mites to be combated, ticks to be combated, parasites to be combated, acarides to be combated, eggs thereof, larvae thereof, pupae thereof and combinations thereof contact at least one composition for combating said living organism, said composition comprising at least as active agent coated siliceous containing particles, said particles having an average primary particle size of less than 100 nm, whereby the coating is a hydrophobic silicon containing coating.

40. The process of claim 39 for combating living organisms present on a living body selected from the group consisting of living body with hair, living body with feather.

41. The process of claim 39 for combating blood sucking living organisms.

42. The process of claim 39 for combating blood sucking living organisms present on chicken.

43. The process of claim 39 for combating living organisms causing health problems for plant.

44. Process for preventing troubles to living body selected from the group consisting of humans, animals and plants due to insects, acarides, mites, ticks and parasites, in which at least a portion of the living body is contacted with a composition for combating said living organism living organism selected from the group consisting of insects to be combated, mites to be combated, acarides to be combated, ticks to be combated, parasites to be combated, eggs thereof, larvae thereof, pupae thereof and combinations thereof, said composition comprising at least as active agent coated siliceous containing particles, said particles having an average primary particle size of less than 100 nm, whereby the coating is a hydrophobic silicon containing coating.

45. Process for combating blood sucking living organisms living on chicken, in which the chicken contacts a composition comprising at least as active agent coated siliceous containing particles, said particles having an average primary particle size comprised between 5 and 40 nm and being provided with a coating at least different from a silanol coating.
